(19) United States
(12) Patent Application Publication
(10) Pub. No.: US 2026/0179651 A1
(43) Pub. Date: Jun. 25, 2026

(54) SERVO CONTROL SYSTEM

(71) Applicant: FANUC CORPORATION, Yamanashi (JP)

(72) Inventors: Yasuyoshi URATA, Yamanashi (JP); Tadashi OKITA, Yamanashi (JP)

(73) Assignee: FANUC CORPORATION, Yamanashi (JP)

(21) Appl. No.: 19/125,720

(22) PCT Filed: Jan. 11, 2023
(86) PCT No.: PCT/JP2023/000463

§ 371 Date: Apr. 29, 2025

(51) Int. Cl. G11B 5/55; G05B 15/02; G11B 5/012; G11B 5/48; G11B 5/49; G11B 5/584; G11B 5/596

(52) U.S. Cl. CPC G11B 5/5526; G05B 15/02; G11B 5/012; G11B 5/4806; G11B 5/4969; G11B 5/5547; G11B 5/584; G11B 5/596; G11B 5/59627; G11B 5/59644; G11B 5/59655

(57) ABSTRACT

A servo control system according to one embodiment of the present disclosure controls a servomotor, and comprises: a servo amplifier that supplies the servomotor with a pulse-width-modulated drive current, and that can change pulse frequencies; and a servo control device that gives the servo amplifier an instruction on the target speed or the target position of the servomotor and the pulse frequencies. The servo control device has: a target instruction unit that gives an instruction on the target speed or the target position; a power consumption calculation unit that calculates, on the basis of information on the servomotor and/or the servo amplifier, the total power consumption of the servomotor and the servo amplifier at each of a plurality of set frequencies set in advance as the pulse frequencies; and a frequency instruction unit that gives the servo amplifier an instruction to perform the pulse width modulation at a set frequency, among the plurality of set frequencies, at which the total power consumption becomes minimum.

### TECHNICAL FIELD

The present invention relates to a servo control system.

### BACKGROUND ART

For example, in order to control a machine tool including a plurality of servo motors, a servo control system is used. Such a servo control system includes a servo amplifier that supplies drive currents to the servo motors, and a servo control device that provides, as a command, target speeds of the servo motors or the like based on a machining program or the like to a servo system. In such a system, in order to suppress heat generation of the motors, a technique has been proposed in which a pulse period of pulse width modulation is lengthened when a drive current value is larger than a threshold level calculated from an excitation frequency (for example, see Patent Document 1).

### CITATION LIST

### Patent Document

Patent Document 1: Japanese Unexamined Patent Application, Publication No. 2005-33972

### DISCLOSURE OF THE INVENTION

### Problems to be Solved by the Invention

The heat generation of the servo motor may be problematic when the load is relatively large. On the other hand, it is desired to reduce the power consumption of the servo system even when the load is relatively small.

### Means for Solving the Problems

A servo control system according to one aspect of the present disclosure is a servo control system for controlling a servo motor. The servo control system includes a servo amplifier that supplies the servo motor with a pulse width modulated drive current and is capable of changing a pulse frequency of pulse width modulation, and a servo control device that provides, as a command, a target speed or a target position of the servo motor and the pulse frequency to the servo amplifier. The servo control device includes a target command unit that provides, as a command, the target speed or the target position, a power consumption calculation unit that calculates a total power consumption of the servo motor and the servo amplifier at each of a plurality of set frequencies set in advance as the pulse frequencies based on information of at least one of the servo motor or the servo amplifier, and a frequency command unit that commands the servo amplifier to perform pulse width modulation at a set frequency that minimizes the total power consumption, among the plurality of set frequencies.

### BRIEF DESCRIPTION OF THE DRAWINGS

FIG. 1 is a schematic diagram showing the configuration of a servo control system according to one embodiment of the present disclosure;

FIG. 2 is a graph showing a relationship between pulse frequency and power consumption at low speed when copper loss is dominant;

FIG. 3 is a graph showing a relationship between pulse frequency and power consumption at high speed when copper loss is dominant;

FIG. 4 is a graph showing a relationship between pulse frequency and power consumption at low torque when iron loss is dominant; and

FIG. 5 is a graph showing a relationship between pulse frequency and power consumption at high torque when iron loss is dominant.

### PREFERRED MODE FOR CARRYING OUT THE INVENTION

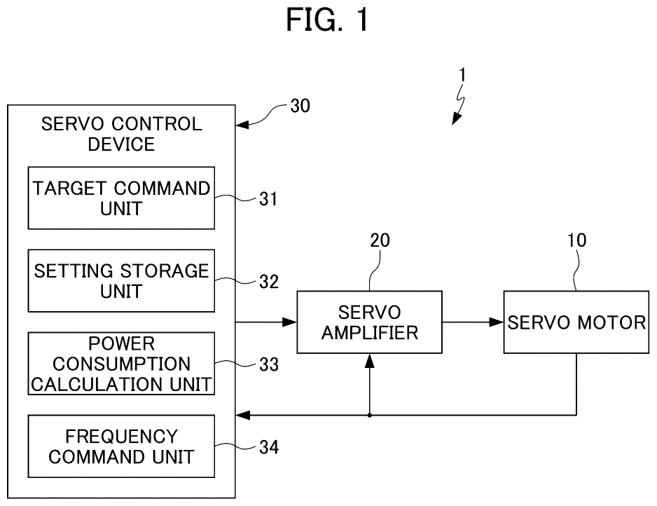

Hereinafter, embodiments of the present disclosure will be described with reference to the drawings. FIG. 1 is a schematic diagram showing the configuration of a servo control system 1 according to one embodiment of the present disclosure.

The servo control system 1 includes a servo motor 10, a servo amplifier 20 that supplies a drive current to the servo motor 10, and a servo control device 30 that inputs a command value to the servo amplifier 20.

The servo motor 10 rotates the shaft by a drive current supplied from the servo amplifier 20. As the servo motor 10 to which the present disclosure is applied, a motor having a relatively large output and large power consumption, specifically, a spindle motor of a machine tool or the like is assumed.

The servo amplifier 20 supplies the servo motor 10 with a pulse width modulated drive current. The servo amplifier 20 is configured to adjust the pulse width (duty ratio) of the drive current so that the speed signal or the position signal fed back from the servo motor 10 matches the target speed or the target position provided, as a command, by the servo control device 30. The servo amplifier 20 is configured to be capable of changing a pulse frequency of pulse width modulation according to a frequency setting command input from the servo control device 30.

The servo control device 30 includes a memory, a processor (CPU), an input/output interface, and the like, and can be realized by one or more computer devices that execute appropriate control programs. The components of the servo control device 30 are ones that fall under categorized functions of the servo control device 30 (operations of the processor), and do not need to be clearly distinguishable in terms of physical configuration or program configuration.

The servo control device 30 includes a target command unit 31 that provides, as a command, a target speed or a target position of the servo motor 10 to the servo amplifier 20, a setting storage unit 32 that stores a plurality of set frequencies set in advance, a power consumption calculation unit 33 that calculates the total power consumption of the servo motor 10 and the servo amplifier 20, and a frequency command unit 34 that provides, as a command, a pulse frequency to the servo amplifier 20.

The target command unit 31 has a well-known configuration and calculates a target speed or a target position of the servo motor 10 at each time according to an operation program describing the operation of the servo motor 10, for example, a machining program describing the operation of a machine tool including the servo motor 10.

The setting storage unit 32 stores a plurality of set frequencies set in advance as pulse frequencies of pulse width modulation in the servo amplifier 20.

The power consumption calculation unit 33 calculates the total power consumption of the servo motor 10 and the servo amplifier 20 at each of the plurality of set frequencies based on information of at least one of the servo motor 10 or the servo amplifier 20.

The power consumption calculation unit 33 can be configured to calculate the total power consumption based on the speed and the torque of the servo motor 10. The power consumption calculation unit 33 can be configured to acquire the speed and the torque of the servo motor 10 from a feedback signal from the servo motor 10 or a control signal of the servo amplifier 20. If the speed and torque of the servo motor 10 can be identified, not only can the power consumption of the servo motor 10 be accurately calculated, but also the power consumption of the servo amplifier 20 can be relatively accurately calculated.

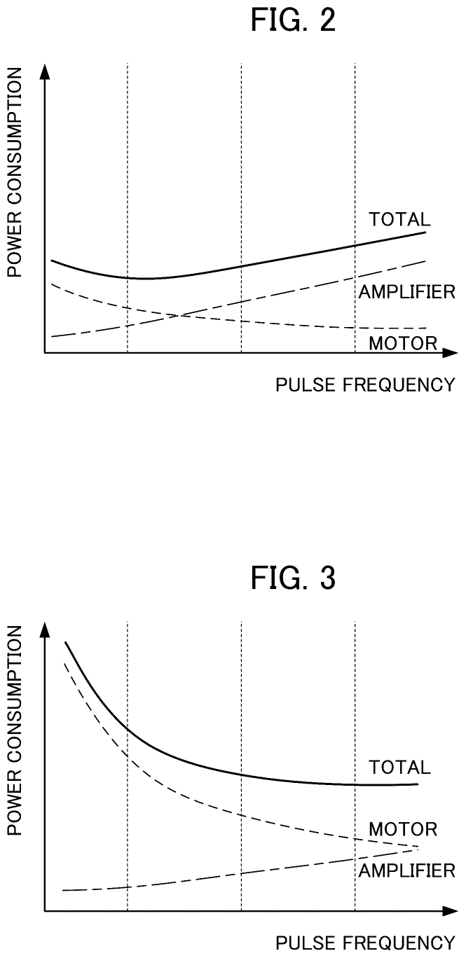

The power consumption calculation unit 33 may be configured to calculate the total power consumption based on only one of the speed or the torque of the servo motor 10. When the ratio of the iron loss of the servo motor 10 to the total power consumption is sufficiently large, the error becomes relatively small even if the total power consumption is calculated based only on the speed of the servo motor 10. FIGS. 2 and 3 each show the relationship between the pulse frequency of pulse width modulation and power consumption when iron loss is dominant. FIG. 2 shows a case where the speed of the servo motor 10 is relatively low, and FIG. 3 shows a case where the speed of the servo motor 10 is relatively high. In each drawing, three set frequencies are indicated by auxiliary lines (broken lines).

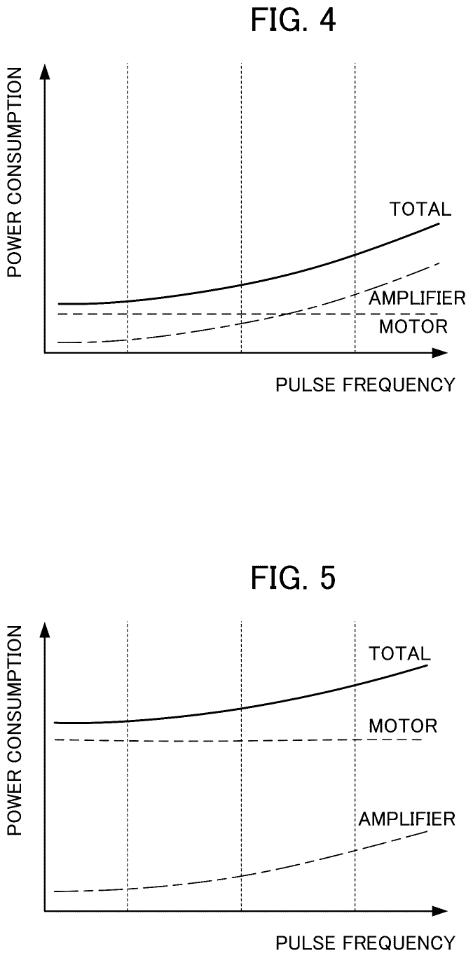

When the ratio of the copper loss of the servo motor 10 to the total power consumption is sufficiently large, the error becomes relatively small even if the total power consumption is calculated based only on the torque of the servo motor 10. FIGS. 4 and 5 each show the relationship between the pulse frequency of pulse width modulation and power consumption when copper loss is dominant. FIG. 4 shows a case where the torque of the servo motor 10 is relatively small, and FIG. 5 shows a case where the torque of the servo motor 10 is relatively large. As described above, the pulse frequency at which the total power consumption becomes the minimum differs depending on not only the speed and the torque of the servo motor 10 but also the device configuration.

The power consumption calculation unit 33 may be configured to calculate the total power consumption using a plurality of reference tables that store in advance the correspondence relationship between at least one of the speed or the torque of the servo motor 10 and the total power consumption for each set frequency. By using the reference tables, the total power consumption can be calculated with a relatively small calculation load, enabling a rapid response to load fluctuations.

The power consumption calculation unit 33 may be configured to calculate the total power consumption when the command of the target command unit 31 is changed. The power consumption calculation unit 33 may be configured to calculate the total power consumption when the speed or the torque of the servo motor 10 changes by a certain amount or more within a predetermined time. In this way, by selecting a time when there is a high probability that the operation state has changed and calculating the total power consumption, unnecessary calculation load can be suppressed.

The frequency command unit 34 commands the servo amplifier 20 to perform pulse width modulation at a set frequency at which the total power consumption calculated by the power consumption calculation unit 33 is minimized among the plurality of set frequencies. This allows the selection of a pulse frequency that can relatively reduce the total power consumption according to the operation state of the servo control system 1.

During no-load operation of the servomotor, the frequency command unit 34 may be configured to provide, as a command, to the servo amplifier 20 a specific set frequency set in advance as a set frequency at which the total power consumption is minimized during no-load operation, regardless of the calculation result of the power consumption calculation unit 33. The no-load operation is, for example, an operation of confirming the operation of a machine tool without attaching a tool or a workpiece to the machine tool, and can be determined by an operation program, an input by a user, or the like. When the no-load operation is apparent, the power consumption can be more reliably suppressed by setting the pulse frequency to be optimal for the no-load operation.

Since the servo control system 1 includes the servo control device 30 including the frequency command unit 34 that commands the servo amplifier 20 to perform pulse width modulation at a set frequency that minimizes the total power consumption calculated by the power consumption calculation unit 33, the pulse frequency of the pulse width modulation by the servo amplifier 20 can be appropriately set according to the operation state, and the power consumption of the entire system can be suppressed.

The following additional remarks are further disclosed with respect to the above-described embodiments and modifications.

### (Additional Remark 1)

A servo control system (1) is a servo control system (1) for controlling a servo motor (10). The servo control system (1) includes a servo amplifier (20) that supplies the servo motor (10) with a pulse width modulated drive current and is capable of changing a pulse frequency of pulse width modulation, and a servo control device (30) that provides, as a command, a target speed or a target position of the servo motor (10) and the pulse frequency to the servo amplifier (20). The servo control device (30) includes a target command unit (31) that provides, as a command, the target speed or the target position, a power consumption calculation unit (33) that calculates a total power consumption of the servo motor (10) and the servo amplifier (20) at each of a plurality of set frequencies set in advance as the pulse frequencies based on information of at least one of the servo motor (10) or the servo amplifier (20), and a frequency command unit (34) that commands the servo amplifier (20) to set, as the pulse frequency, a set frequency that minimizes the total power consumption, among the plurality of set frequencies.

### (Additional Remark 2)

In the servo control system (1) according to additional remark 1, the power consumption calculation unit (33) may calculate the total power consumption based on at least one of a speed or a torque of the servo motor (10).

### (Additional Remark 3)

In the servo control system (1) according to additional remark 2, the power consumption calculation unit (33) may calculate the total power consumption using a plurality of reference tables that store in advance a correspondence relationship between at least one of the speed or the torque of the servo motor (10) and the total power consumption for each of the set frequencies.

### (Additional Remark 4)

In the servo control system (1) according to any one of additional remarks 1 to 3, the power consumption calculation unit (33) may calculate the total power consumption when a command of the target command unit (31) is changed or when a speed of the servo motor (10) changes by a certain amount or more.

### (Additional Remark 5)

In the servo control system (1) according to any one of additional remarks 1 to 4, the frequency command unit (34) may provide, as a command, a specific set frequency set in advance to the servo amplifier (20) during no-load operation of the servo motor (10), regardless of a calculation result of the power consumption calculation unit (33).

Although the present disclosure has been described in detail above, the present disclosure is not limited to the individual embodiments described above. Various additions, substitutions, modifications, partial deletions, and the like can be made to these embodiments without departing from the gist of the present disclosure or the spirit of the present disclosure derived from the contents recited in the claims and the equivalents thereof. These embodiments can also be implemented in combination. For example, in the above-described embodiments, the order of each operation and the order of each process are shown as examples, and the present disclosure is not limited thereto. The same applies to the case where numerical values or numerical expressions are used in the descriptions of the above-described embodiments.

### EXPLANATION OF REFERENCE NUMERALS

1 servo control system
10 servo motor
20 servo amplifier
30 servo control device
31 target command unit
32 setting storage unit
33 power consumption calculation unit
34 frequency command unit

1. A servo control system for controlling a servo motor, comprising:
a servo amplifier that supplies the servo motor with a pulse width modulated drive current and is capable of changing a pulse frequency of pulse width modulation; and
a servo control device that provides, as a command, a target speed or a target position of the servo motor and the pulse frequency to the servo amplifier,
the servo control device comprising:
a target command unit that provides, as a command, the target speed or the target position;
a power consumption calculation unit that calculates a total power consumption of the servo motor and the servo amplifier at each of a plurality of set frequencies set in advance as the pulse frequencies based on information of at least one of the servo motor or the servo amplifier; and
a frequency command unit that commands the servo amplifier to set, as the pulse frequency, a set frequency that minimizes the total power consumption, among the plurality of set frequencies.

2. The servo control system according to claim 1, wherein the power consumption calculation unit calculates the total power consumption based on at least one of a speed or a torque of the servo motor.

3. The servo control system according to claim 2, wherein the power consumption calculation unit calculates the total power consumption using a plurality of reference tables that store in advance a correspondence relationship between at least one of the speed or the torque of the servo motor and the total power consumption for each of the set frequencies.

4. The servo control system according to claim 1, wherein the power consumption calculation unit calculates the total power consumption when a command of the target command unit is changed or when a speed or a torque of the servo motor changes by a certain amount or more.

5. The servo control system according to claim 1, wherein the frequency command unit provides, as a command, a specific set frequency set in advance to the servo amplifier during no-load operation of the servo motor, regardless of a calculation result of the power consumption calculation unit.
